(19) United States
(12) Patent Application Publication
(10) Pub. No.: US 2006/0174254 A1
(43) Pub. Date: Aug. 3, 2006

(54) Pickup unit, drive unit, recording medium drive, and electronic device

(76) Inventors: Takeharu Takasawa, Kanagawa (JP); Nobuhiko Tsukahara, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/337,564

(22) Filed: Jan. 24, 2006

(30) Foreign Application Priority Data
Feb. 3, 2005 (JP) P2005-027466

(51) Int. Cl. G11B 7/08; G11B 7/085; G11B 7/09

(52) U.S. Cl. 720/676

(57) ABSTRACT

A pickup unit includes a pickup unit base having pickup means for recording and/or playing back information on a recording medium, a bearing fitted around the circumferential surface of a guide member for guiding the pickup unit base, and attachment means for detachably attaching the bearing to a side of the pickup unit base.

### CROSS REFERENCES TO RELATED APPLICATIONS

The present invention contains subject matter related to Japanese Patent Application JP 2005-027466 filed in the Japanese Patent Office on Feb. 3, 2005, the entire contents of which are incorporated herein by reference.

### BACKGROUND OF THE INVENTION

1. Field of the Invention

The present invention relates to pickup units for recording and/or playing back, for example, video information on disc-shaped recording media including optical discs, such as CDs, CD-ROMs, CD-R/RWs, DVDs, and recordable DVDs, and magneto-optical discs, and also relates to drive units including the pickup units, recording medium drives including the drive units, and electronic devices including the recording medium drives.

2. Description of the Related Art

Optical disc drives are an example of disc drives that record and/or play back video information on disc-shaped recording media including optical discs, such as CDs, CD-ROMs, CD-R/RWs, DVDs, and recordable DVDs, and magneto-optical discs. Known optical disc drives (according to, for example, Japanese Unexamined Patent Application Publications Nos. 2001-325776, 2004-6037, and 2004-132450) include a casing, a load/eject slide base that can be drawn from the casing, and an optical disc drive unit elastically supported by insulators inside an opening of the slide base.

The optical disc drive unit includes an optical disc drive unit base having a spindle motor for rotating an optical disc, as a disc-shaped recording medium, and an optical pickup unit carrying mechanism. An optical pickup unit is mounted inside an opening of the optical disc drive unit base. The optical pickup unit includes an optical pickup unit base having an optical pickup, as pickup means, for recording and/or playing back video information on the optical disc. The optical pickup unit carrying mechanism moves the optical pickup unit base in the radial direction of the optical disc in the opening of the optical disc drive unit base while being guided by main and auxiliary guide shafts so that the optical pickup can record and/or play back video signals on the optical disc.

Recently, thinner optical disc drives have been demanded for use in notebook personal computers (PCs) with further reductions in the sizes and thicknesses of notebook PCs. Development of thinner optical pickup unit bases, which are bases for optical pickup units, is extremely important in terms of achieving thinner optical disc drives.

Referring to FIG. 12A, an optical pickup unit base 100 of a known optical disc drive, a base for an optical pickup unit on which an optical pickup is mounted, is formed by, for example, die casting with aluminum, and has a thickness T10 of 5 mm or more.

A bearing press-fit hole 101 is formed at a side 100a of the optical pickup unit base 100 in the center P10 of the thickness T10 thereof. A cylindrical oil-retaining metal bearing 102 is mechanically press-fitted into the bearing press-fit hole 101 and is slidably fitted around the circumferential surface of a main guide shaft 103 provided on the optical disc drive unit base in parallel.

If the optical pickup unit base 100 has a sufficient thickness T10, namely 5 mm or more, the oil-retaining metal bearing 102 can be mechanically press-fitted into the bearing press-fit hole 101 of the optical pickup unit base 100 without causing creeping or cracking at portions 100b above and below the bearing press-fit hole 101. If, for example, the oil-retaining metal bearing 102 has an outer diameter Φ10 of 2.3 mm, the portions 100b above and below the bearing press-fit hole 101 have a thickness t10 of 1.35 mm or more, which is sufficient in terms of strength. The oil-retaining metal bearing 102 can therefore be safely and easily press-fitted into the bearing press-fit hole 101.

The present inventors, however, have found by experiment that a problem occurs when the thickness of the optical disc drive unit base 100 is reduced.

Referring to FIG. 12B, the optical disc drive unit base 100 has a thickness T11 of 3 mm, and the main guide shaft 103 has a diameter Φ12 of 1.5 mm, which is the lower limit in terms of strength. Because the lower limit of the wall thickness t11 of the oil-retaining metal bearing 102 is 0.4 mm in terms of strength, the oil-retaining metal bearing 102, which is press-fitted into the bearing press-fit hole 101, has an outer diameter Φ11 of 2.3 mm. In consequence, the portions 100b above and below the bearing press-fit hole 101 have an extremely small thickness t10, namely 0.35 mm.

When the oil-retaining metal bearing 102 is mechanically press-fitted into the bearing press-fit hole 101, creeping or cracking 104 undesirably occurs at the portions 100b above and below the oil-retaining metal bearing 102 because of the extremely small thickness t10.

### SUMMARY OF THE INVENTION

The present inventors have recognized that an optical pickup unit base with a minimized thickness can creep and crack around the circumferential surface of a bearing, such as an oil-retaining metal bearing, when the bearing is attached to a side of the optical pickup unit base.

A pickup unit according to an embodiment of the present invention includes a pickup unit base having pickup means for recording and/or playing back information on a recording medium, a bearing fitted around the circumferential surface of a guide member for guiding the pickup unit base, and attachment means for detachably attaching the bearing to a side of the pickup unit base.

A drive unit according to another embodiment of the present invention includes a drive unit base and a pickup unit. The drive unit base includes a motor for driving a recording medium, a pickup unit carrying mechanism, and first and second guide members. The pickup unit is supported movably by the first and second guide members in an opening provided in the drive unit base. The pickup unit includes a pickup unit base having pickup means for recording and/or playing back information on the recording medium, a bearing fitted around the circumferential surface of the first guide member, and attachment means for detachably attaching the bearing to a side of the pickup unit base.

A recording medium drive according to another embodiment of the present invention includes a drive unit including a drive unit base and a pickup unit. The drive unit base includes a motor for driving a recording medium, a pickup unit carrying mechanism, and first and second guide members. The pickup unit is supported movably by the first and second guide members in an opening provided in the drive unit base. The pickup unit includes a pickup unit base having pickup means for recording and/or playing back information on the recording medium, a bearing fitted around the circumferential surface of the first guide member, and attachment means for detachably attaching the bearing to a side of the pickup unit base.

An electronic device according to another embodiment of the present invention includes a recording medium drive having a drive unit including a drive unit base and a pickup unit. The drive unit base includes a motor for driving a recording medium, a pickup unit carrying mechanism, and first and second guide members. The pickup unit is supported by the first and second guide members in an opening provided in the drive unit base movably in the radial direction of the recording medium and is carried by the pickup unit carrying mechanism in the radial direction of the recording medium. The pickup unit includes a pickup unit base having pickup means for recording and/or playing back information on the recording medium, a bearing fitted around the circumferential surface of the first guide member, and attachment means for detachably attaching the bearing to a side of the pickup unit base.

In the pickup unit, the drive unit, the recording medium drive, and the electronic device according to the embodiments of the present invention, the thickness of the pickup unit base can be minimized without causing creeping or cracking at part of the pickup unit base around the bearing when the bearing is attached thereto. There is no need for the step of press-fitting for attaching the bearing to the side of the pickup unit base, and thus no creeping or cracking occurs at the part of the pickup unit base around the bearing. Accordingly, a high-quality, ultrathin pickup unit base can be readily produced to provide an ultrathin pickup unit, drive unit, recording medium drive, and electronic device.

To attach the bearing to the pickup unit base with high accuracy and high efficiency, one or both of the pickup unit base and the attachment means may have a positioning part for positioning the bearing, and the attachment means may have two attachment portions to simultaneously attach two bearings to the pickup unit base.

The attachment means may be formed of a leaf spring to ensure that the attachment means can be accommodated within the thickness of the pickup unit base. In addition, the leaf spring may be attached to the pickup unit base such that the leaf spring is bent substantially 180° or more along the circumferential surface of the bearing, thus easily and tightly attaching the bearing to the pickup unit base using the leaf spring.

The bearing may have an annular recess formed substantially in the center of the circumferential surface of the bearing in the axial direction thereof. The recess engages with the attachment means. The recess can simplify the structure of the attachment means and ensures that the attachment means can be accommodated within the thickness of the pickup unit base. In addition, preferably, the pickup unit carrying mechanism includes a lead screw having a spiral groove, and the pickup unit base further has an engaging member engaging elastically with the spiral groove and an elastic engaging member support disposed at a part of the leaf spring and supporting the engaging member. The leaf spring can then be used not only to attach the bearing to the side of the pickup unit base, but also to attach the engaging member to the pickup unit base. As a result, the numbers of components and steps for assembly can be reduced to achieve cost reduction.

### BRIEF DESCRIPTION OF THE DRAWINGS

FIG. 1 is an overall perspective view of an optical disc drive according to a first embodiment of the present invention;

FIG. 2 is a perspective view showing an optical disc drive unit and an optical pickup unit of the optical disc drive;

FIG. 3 is a perspective view of the optical pickup unit of the optical disc drive;

FIG. 4 is an exploded perspective view showing an attachment mechanism for attaching oil-retaining metal bearings to an optical pickup unit base of the optical pickup unit;

FIG. 5 is an exploded perspective view from below showing the attachment mechanism for attaching the oil-retaining metal bearings to the optical pickup unit base;

FIG. 6 is a longitudinal sectional view of the attachment mechanism for attaching the oil-retaining metal bearings;

FIG. 7 is a partial plan view of the attachment mechanism shown in FIG. 6;

FIG. 8 is a longitudinal sectional view of an attachment mechanism for attaching oil-retaining metal bearings to an optical pickup unit base according to a second embodiment of the present invention;

FIG. 9 is a partial plan view of the attachment mechanism shown in FIG. 8;

FIG. 10 is a partial plan view of an attachment mechanism for attaching an oil-retaining metal bearing to an optical pickup unit base according to a third embodiment of the present invention;

FIG. 11 is a longitudinal sectional view taken along line XI-XI in FIG. 10; and

FIGS. 12A and 12B are sectional views for illustrating a study to reduce the thickness of an optical pickup unit base.

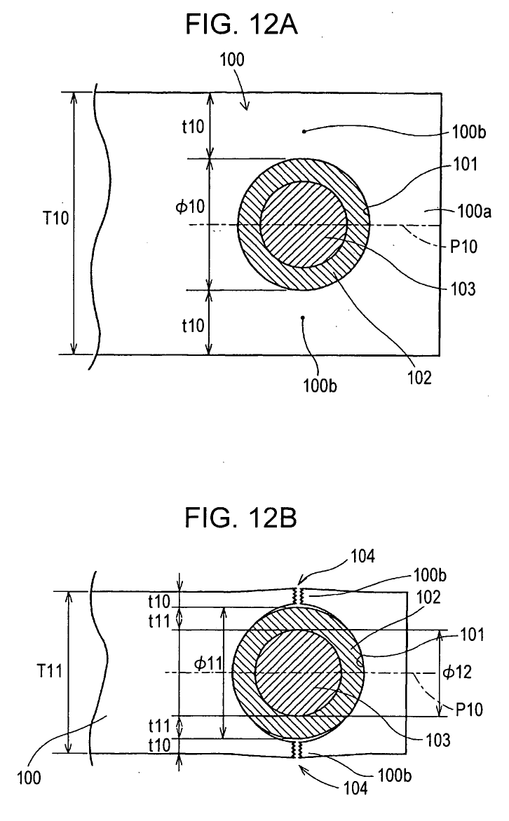

### DESCRIPTION OF THE PREFERRED EMBODIMENTS

### First Embodiment

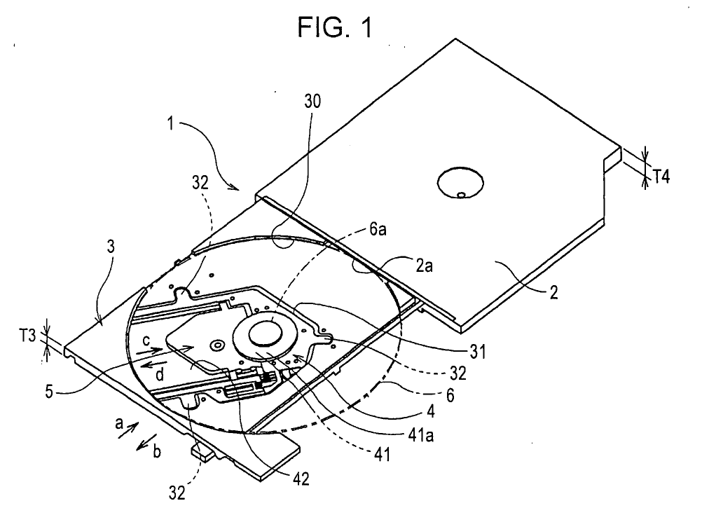

A disc drive according to a first embodiment of the present invention will now be described with reference to FIGS. 1 to 7. The disc drive is an ultrathin optical disc drive that is compatible with optical discs with a diameter of 12 cm and is suitable for applications including notebook PCs.

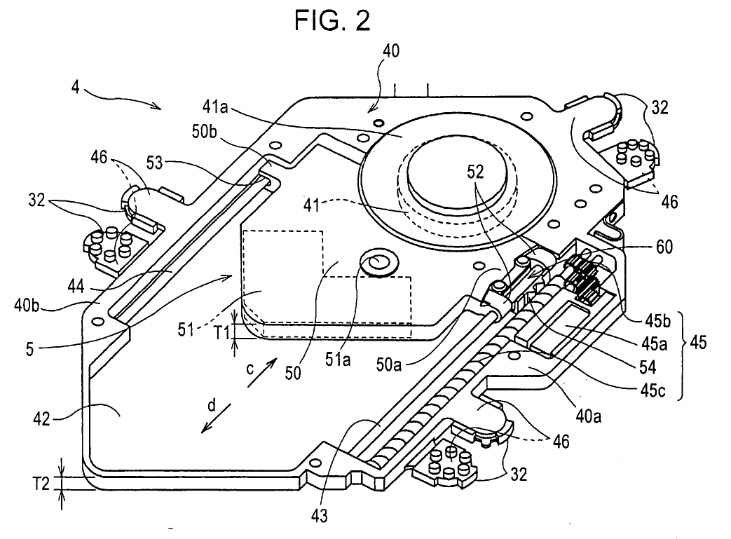

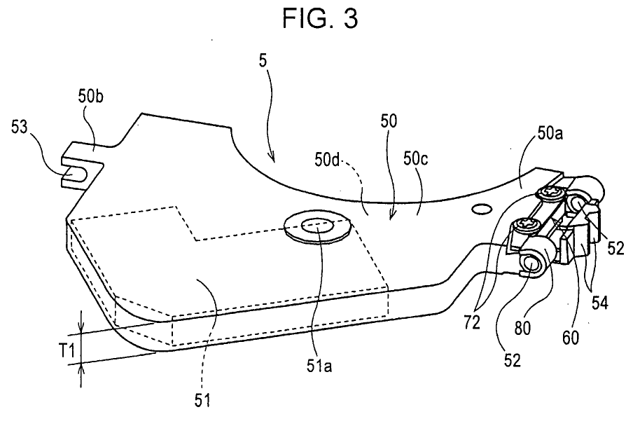

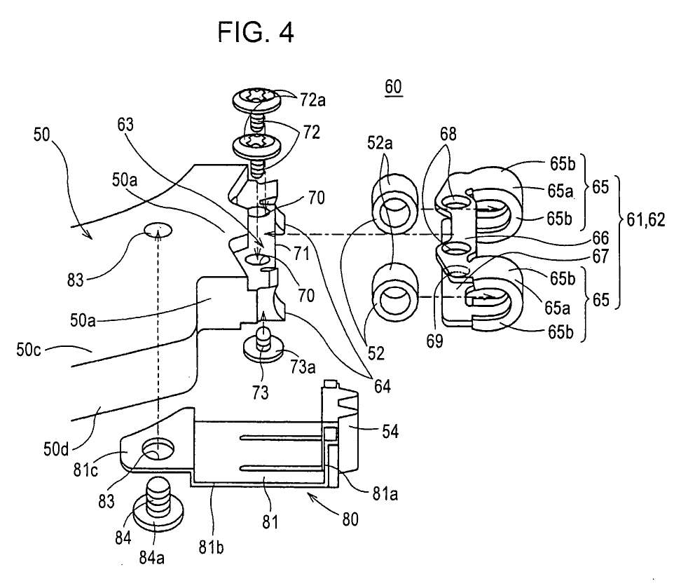

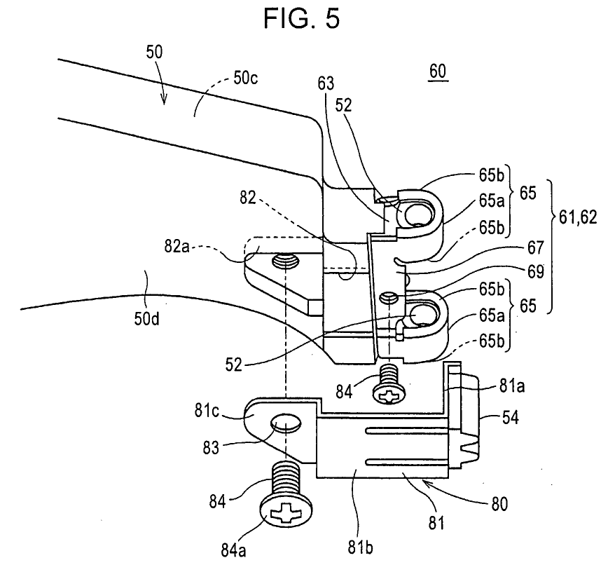

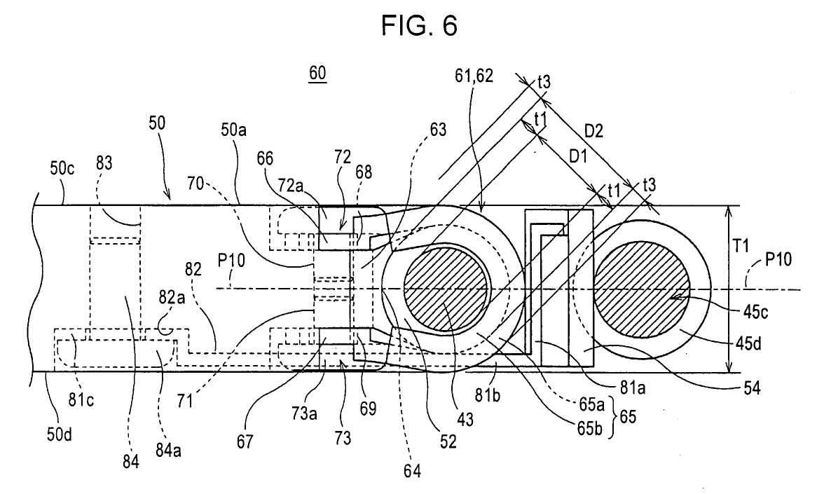

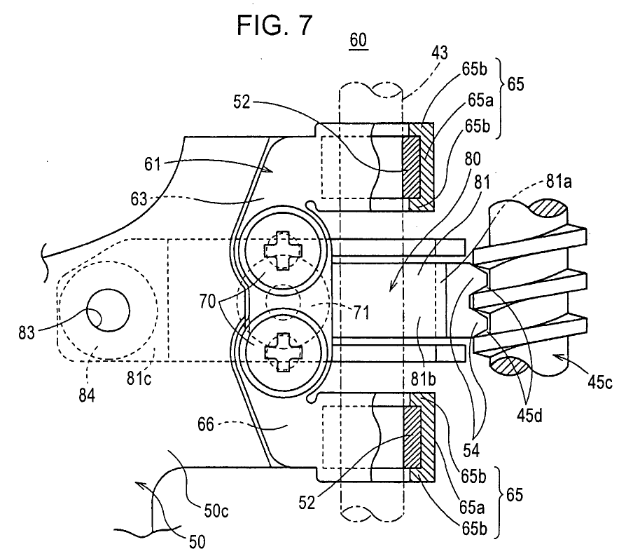

FIG. 1 is a perspective view showing the overall optical disc drive. FIG. 2 is a perspective view showing an optical disc drive unit and an optical pickup unit mounted on a slide base of the optical disc drive. FIG. 3 is an enlarged perspective view of the optical pickup unit. FIG. 4 is an exploded perspective view showing an attachment mechanism for attaching oil-retaining metal bearings, as an example of a bearing, to an optical pickup unit base of the optical pickup unit and an attachment mechanism for attaching an engaging member that engages with a lead screw of an optical pickup unit carrying mechanism, as an example of a pickup unit carrying mechanism. FIG. 5 is an exploded perspective view from the bottom side in FIG. 4. FIG. 6 is a longitudinal sectional view of an assembly of the members shown in FIG. 4. FIG. 7 is a plan view of the assembly shown in FIG. 6.

The overall structure of the optical disc drive is outlined below with reference to FIGS. 1 and 2. An ultrathin optical disc drive 1 according to the first embodiment of the present invention includes a flat, hollow casing 2 and a load/eject slide base (hereinafter simply referred to as a slide base) 3 that is loaded into and ejected from an opening 2a provided at a side of the casing 2 in directions parallel to the casing 2, which are indicated by the arrows a and b. A flat optical disc drive unit 4, as an example of a drive unit, and a flat optical pickup unit 5, as an example of a pickup unit, are mounted on the slide base 3.

The optical disc drive unit 4 has a flat optical disc drive unit base 40, as an example of a drive unit base, and the optical pickup unit base 50 has a flat optical pickup unit base 50, as an example of a pickup unit base.

A loading mechanism (not shown) is provided at the side of the casing 2 so that the slide base 3 can be loaded into and ejected from the opening 2a at the side of the casing 2 in the directions indicated by the arrows a and b.

A circular recess 30 is formed on the top surface of the slide base 3 so that an optical disc 6 with a diameter of 12 cm, as an example of disc-shaped recording media including optical discs, such as CDs, CD-ROMs, CD-R/RWs, DVDs, and recordable DVDs, and magneto-optical discs, can be accommodated in parallel with the casing 2. An opening 31 is formed in the bottom of the recess 30 in the shape corresponding to the optical disc drive unit 4, which has an unequal-sided polygonal shape. The optical disc drive unit 4 is mounted inside the opening 31 in parallel with the slide base 3 with flat insulators disposed between the optical disc drive unit 4 and the slide base 3. The insulators are formed of an elastic material such as rubber.

The optical disc drive unit base 40, which has an unequal-sided polygonal shape, serves as the outer frame of the optical disc drive unit 4. A spindle motor 41 is mounted perpendicularly at an end of the optical disc drive unit base 40. The spindle motor 41 has a turntable 41a positioned in the center of the recess 30 and facing upward. The optical disc 6 is accommodated in the recess 30 of the slide base 3 in parallel with the slide base 3 with a central hole 6a detachably fitted to the turntable 41a. An opening 42 having an unequal-sided polygonal shape is provided inside the optical disc drive unit base 40 beside the spindle motor 41.

The optical pickup unit 5 has an optical pickup 51 (pickup means) incorporated in the optical pickup unit base 50, which has an unequal-sided polygonal shape. The optical pickup 51 has an objective lens 51a disposed on the top surface of the optical pickup unit base 50 near the spindle motor 41 and facing upward. The optical pickup unit 5 is disposed inside the opening 42 provided beside the spindle motor 41 in parallel with the optical disc drive unit base 40.

The optical pickup unit base 50 can be slid in directions indicated by the arrows c and d, that is, in the radial direction of the optical disc 6, while being guided by a main guide shaft 43 and an auxiliary guide shaft 44. The guide shafts 43 and 44 are cylindrical shafts extending along sides 40a and 40b of the optical disc drive unit base 40 in parallel on both sides of the opening 42. The optical pickup unit base 50 is slid in the directions indicated by the arrows c and d by an optical pickup unit carrying mechanism 45, as an example of a pickup unit carrying mechanism, mounted at the side 40a of the optical disc drive unit base 40.

Cylindrical oil-retaining metal bearings 52 (see FIG. 3), as described later, are slidably fitted around the circumferential surface of the main guide shaft 43 at a side 50a of the optical pickup unit base 50. A substantially U-shaped engaging portion 53 engages slidably with the auxiliary guide shaft 44 at the opposite side 50b of the optical pickup unit base 50.

The carrying mechanism 45 is mounted at the side 40a of the optical disc drive unit base 40. The carrying mechanism 45 includes a spindle motor 45a accommodated within the thickness of the optical disc drive unit base 40, a gear train 45b, and a lead screw 45c that is rotated by the spindle motor 45a through the gear train 45b to slide the optical pickup unit 5. The lead screw 45c is disposed beside the main guide shaft 43 in parallel. An engaging member 54 is attached to the side 50a of the optical pickup unit base 50. This engaging member 54 is formed in a shape substantially similar to rack teeth to engage with a spiral groove 45d (see FIG. 7) formed on the circumferential surface of the lead screw 45c.

As the spindle motor 45a rotates the lead screw 45c in the forward or reverse direction through the gear train 45b, the optical pickup unit base 50 slides in the directions indicated by the arrows c and d while being guided by the guide shafts 43 and 44. The insulators 32 are attached to opposite surfaces of insulator supports 46 formed on the periphery of the optical disc drive unit base 40 so that the inner edges of the slide base 3 around the opening 31 can be elastically held between the insulator supports 46.

The optical disc drive 1 having the above structure is used by incorporating the casing 2 into a slit of, for example, a notebook PC. The optical disc 6 is attached to the turntable 41a of the spindle motor 41 in parallel with the slide base 3, and the loading mechanism loads the slide base 3 into the casing 2 in the direction indicated by the arrow a.

The spindle motor 41 is driven to rotate the optical disc 6 in response to disc recording/playback signals from the computer. While the objective lens 51a of the optical pickup 51 focuses a light beam onto the bottom surface of the optical disc 6, the carrying mechanism 45 slides the optical pickup unit base 50 in the directions indicated by the arrows c and d, that is, in the radial direction of the optical disc 6, for seeking and tracking to record or play back, for example, video information on the optical disc 6.

According to the first embodiment of the present invention, the thickness T1 of the optical pickup unit base 50 can be reduced to 3 mm or less using the attachment mechanism 60 for attaching the oil-retaining metal bearings 52 to the side 50a of the optical pickup unit base 50. The thickness T2 of the optical disc drive unit base 40, which is independent of the attachment mechanism 60, is reduced to 3 mm or less, and the thickness T3 of the slide base 3 is reduced to 6.5 mm or less. Accordingly, the thickness T4 of the casing 2 can be reduced to 8 mm or less.

The attachment mechanism 60 is described below with reference to FIGS. 3 to 7 as an important factor to achieve ultrathin optical disc drive.

Referring to FIG. 6, the main guide shaft 43 has a diameter D1 of 1.5 mm, which is the lower limit in terms of strength. The oil-retaining metal bearings 52 have a wall thickness t1 of 0.4 mm, which is the lower limit in terms of strength, and an outer diameter D2 of 2.3 mm. Accordingly, the difference between the thickness T1 of the optical pickup unit base 50 and the outer diameter D2 of the oil-retaining metal bearings 52, T1−D2, is 0.7 mm. The attachment mechanism 60 includes a leaf spring 62 formed of, for example, a stainless steel plate and having a thickness t3 of 0.35 mm or less as an attachment member 61. The auxiliary guide shaft 44 has a diameter of 1.5 to 2.0 mm.

A bearing attachment portion 63 having top and bottom uniform steps is formed at the side 50a of the optical pickup unit base 50 in the center of the thickness thereof. This bearing attachment portion 63 has two positioning parts 64 for positioning the two oil-retaining metal bearings 52. These positioning parts 64 are separated in the axial direction of the main guide shaft 43, and have an arc shape with the same center and radius as the circumferential surfaces 52a of the oil-retaining metal bearings 52.

The attachment member 61 (attachment means), which is formed of the leaf spring 62, has two attachment portions 65 bent substantially 180° or more along the circumferential surfaces 52a of the two oil-retaining metal bearings 52 and a pair of top and bottom coupling portions 66 and 67 that are substantially symmetrical. The coupling portions 66 and 67 are integrally formed with the attachment portions 65 so as to couple them. The attachment portions 65 each have an arc-shaped circumferential surface 65a and arc-shaped inner ribs 65b bent inward at a substantially right angle on both sides of the circumferential surface 65a; that is, the attachment portions 65 have a substantially U-shaped cross-section. The coupling portion 66 has one or two screw holes 68, and the coupling portion 67 has one or two screw holes 69. The bearing attachment portion 63 has one or two screw holes 70 formed perpendicularly on the top surface thereof and one or two screw holes 71 formed perpendicularly on the bottom surface thereof.

In the attachment mechanism 60 having the above structure according to the first embodiment, the two oil-retaining metal bearings 52 are fitted to the two attachment portions 65 of the attachment member 61, which is formed of the leaf spring 62. Then the circumferential surfaces 65a of the attachment portions 65 are bent substantially 180° or more along the circumferential surfaces 52a of the oil-retaining metal bearings 52.

The circumferential surfaces 52a of the oil-retaining metal bearings 52 are pressed against the positioning parts 64 of the bearing attachment portion 63 of the optical pickup unit base 50. Attachment screws 72 and 73 are then threaded into the screw holes 70 and 71 on the top and bottom surfaces of the bearing attachment portion 63 through the screw holes 68 and 69 of the pair of coupling portions 66 and 67. The attachment member 61 thus holds the two oil-retaining metal bearings 52 in a substantially symmetrical manner so that the bearings 52 can be attached with high accuracy to the side 50a of the optical pickup unit base 50 concentrically in the center P10 of the thickness T1 thereof.

The overall attachment mechanism 60 can be accommodated within the thickness T1 of the optical pickup unit base 50 if, for example, the attachment member 61 is formed of the leaf spring 62 with a thickness t3 of 0.35 mm or less, the circumferential surfaces 65a of the attachment portions 65 are symmetrically bent substantially 180° or more along the circumferential surfaces 52a of the oil-retaining metal bearings 52, and the attachment screws 72 and 73 are threaded until heads 72a and 73a thereof seat inside the top and bottom surfaces of the optical pickup unit base 50. This attachment mechanism 60 allows simultaneous, efficient attachment of the two oil-retaining metal bearings 52 with the single attachment member 61 to reduce the number of steps for attachment (assembly).

As shown in FIGS. 3 to 7, the engaging member 54, which engages with the spiral groove 45d of the lead screw 45c of the carrying mechanism 45, is integrally formed with a perpendicular portion 81a of an attachment member 80. The attachment member 80 is formed of a substantially L-shaped leaf spring 81 made of, for example, a synthetic resin. A parallel portion 81b of the leaf spring 81 is fitted to a recess 82 formed on the bottom surface 50d of the optical pickup unit base 50.

A stepped portion 81c is formed at the end of the parallel portion 81b opposite the perpendicular portion 81a. This stepped portion 81c is fitted to a deep recess portion 82a provided at an end of the recess 82 on the bottom surface 50d of the optical pickup unit base 50. An attachment screw 84 is threaded through a screw hole 83 formed in the stepped portion 81c to fasten the leaf spring 81 to the optical pickup unit base 50 in the recess 82a thereof. A head 84a of the attachment screw 84 is seated inside the bottom surface 50d of the optical pickup unit base 50.

Accordingly, the leaf spring 81, the attachment screw 84, and the engaging member 54 supported at an end of the leaf spring 84 can all be accommodated within the thickness T1 of the optical pickup unit base 50. The engaging member 54 engages elastically with the spiral groove 45d of the lead screw 45c by means of the elasticity of the perpendicular portion 81a of the leaf spring 81.

### Second Embodiment

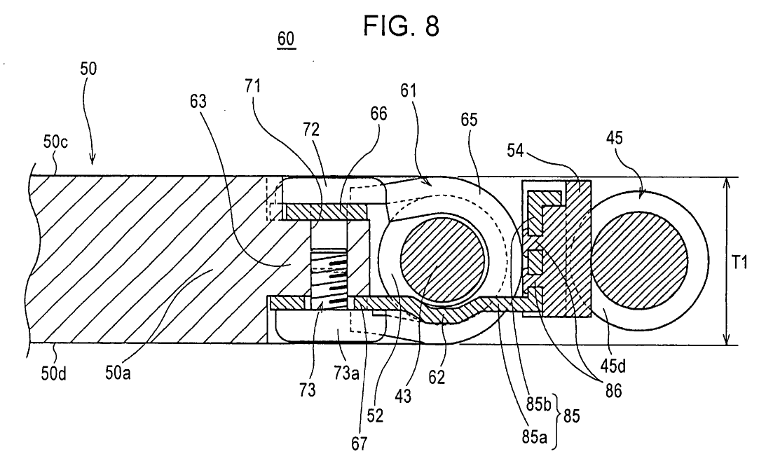

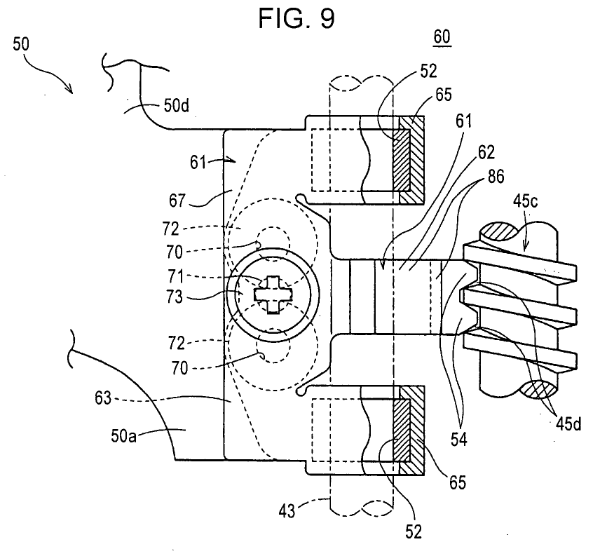

An ultrathin optical disc drive having the attachment mechanism 60 according to a second embodiment of the present invention will now be described with reference to FIGS. 8 and 9. FIG. 8 is a longitudinal sectional view of the attachment mechanism 60. FIG. 9 is a plan view of the attachment mechanism 60 shown in FIG. 8.

In the second embodiment, an engaging member support 85 is integrally formed with the attachment member 61 (attachment means) described in the first embodiment. For example, the engaging member support 85 is disposed in substantially the center of the lower coupling portion 67 of the attachment member 61. The engaging member support 85 is substantially L-shaped, including a parallel portion 85a and a perpendicular portion 85b disposed at the front end thereof. The engaging member 54, which is formed of, for example, a synthetic resin, is fixed to the front surface of the perpendicular portion 85b with fixing means 86 such as weld dowel pins. As in the first embodiment, additionally, the engaging member 54 engages elastically with the spiral groove 45d of the lead screw 45c by means of the elasticity of the engaging member support 85 of the leaf spring 62.

In the attachment mechanism 60 for attaching the oil-retaining metal bearings 52 according to the second embodiment, the single attachment member 61 may be used to simultaneously attach the two oil-retaining metal bearings 52 and the engaging member 54, which engages with the spiral groove 45d of the lead screw 45c, to the side 50a of the optical pickup unit base 50. The attachment mechanism 60 can therefore reduce the numbers of components and steps for attachment (assembly) to achieve cost reduction.

### Third Embodiment

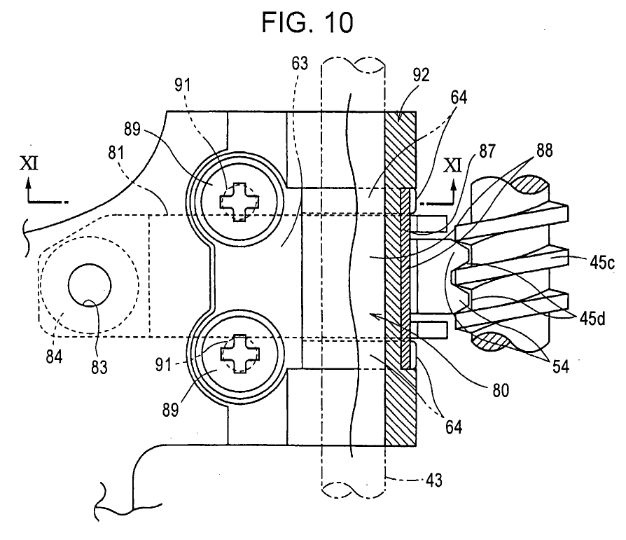

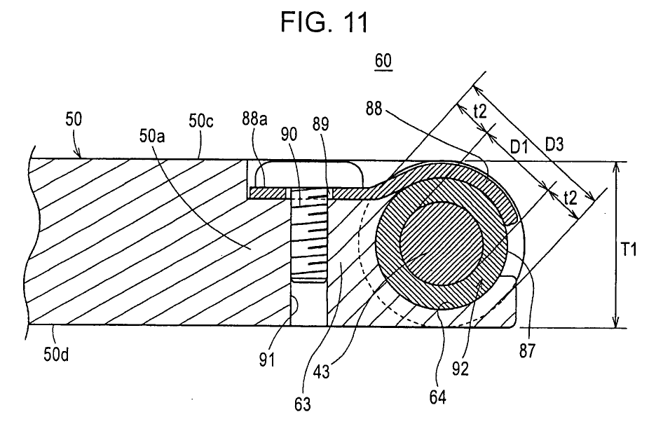

An ultrathin optical disc drive having the attachment mechanism 60 according to a third embodiment of the present invention will now be described with reference to FIGS. 10 and 11. FIG. 10 is a partial plan view of the attachment mechanism 60. FIG. 11 is a longitudinal sectional view taken along line XI-XI in FIG. 10.

In the third embodiment, an elongated cylindrical oil-retaining metal bearing 92 is used. The oil-retaining metal bearing 92 has an outer diameter D3 of 3 mm or less and a wall thickness t2 of 0.4 mm or more. An annular recess 87 is formed in substantially the center of the circumferential surface of the oil-retaining metal bearing 92 in the axial direction thereof.

The oil-retaining metal bearing 92 is placed onto the top of the bearing attachment portion 63 from above in an oblique direction with the annular recess 87 fitted between the pair of positioning parts 64. An attachment member 88 is then fitted to the annular recess 87 of the oil-retaining metal bearing 92 from above in an oblique direction.

Screw holes 89 are formed at a base end 88a of the attachment member 88. Attachment screws 90 are threaded and fixed from above through the screw holes 89 into screw holes 91 formed in the bearing attachment portion 63 of the optical pickup unit base 50. The oil-retaining metal bearing 92, the attachment member 88, and the attachment screws 90 are accommodated within the thickness T1 of the optical pickup unit base 50.

The attachment mechanism 60 for attaching the oil-retaining metal bearing 92 according to the third embodiment can simplify the structure and processing of the attachment member 88 and reduce the number of steps for assembly to achieve cost reduction. In addition, the overall attachment mechanism 60 can readily be accommodated within the thickness T1 of the optical pickup unit base 50. The attachment member 80 for attaching the engaging member 54 to the bottom surface 50d of the optical pickup unit base 50, as described above, is accommodated between the pair of positioning parts 64 within the thickness T1 of the optical pickup unit base 50.

It should be understood by those skilled in the art that various modifications, combinations, sub-combinations and alterations may occur depending on design requirements and other factors insofar as they are within the scope of the appended claims or the equivalents thereof.

What is claimed is:

1. A pickup unit comprising:
a pickup unit base having pickup means for recording and/or playing back information on a recording medium;
a bearing fitted around the circumferential surface of a guide member for guiding the pickup unit base; and
attachment means for detachably attaching the bearing to a side of the pickup unit base.

2. A drive unit comprising:
a drive unit base including
a motor for driving a recording medium,
a pickup unit carrying mechanism, and
first and second guide members; and
a pickup unit supported movably by the first and second guide members in an opening provided in the drive unit base, the pickup unit including
a pickup unit base having pickup means for recording and/or playing back information on the recording medium,
a bearing fitted around the circumferential surface of the first guide member, and
attachment means for detachably attaching the bearing to a side of the pickup unit base.

3. A recording medium drive comprising a drive unit including:
a drive unit base including
a motor for driving a recording medium,
a pickup unit carrying mechanism, and
first and second guide members; and
a pickup unit supported movably by the first and second guide members in an opening provided in the drive unit base, the pickup unit including
a pickup unit base having pickup means for recording and/or playing back information on the recording medium,
a bearing fitted around the circumferential surface of the first guide member, and
attachment means for detachably attaching the bearing to a side of the pickup unit base.

4. The recording medium drive according to claim 3, wherein one or both of the pickup unit base and the attachment means have a positioning part for positioning the bearing.

5. The recording medium drive according to claim 3, wherein the attachment means has two attachment portions to simultaneously attach two bearings to the pickup unit base.

6. The recording medium drive according to claim 3, wherein the attachment means is formed of a leaf spring.

7. The recording medium drive according to claim 6, wherein the leaf spring is attached to the pickup unit base such that the leaf spring is bent substantially 180° or more along the circumferential surface of the bearing.

8. The recording medium drive according to claim 3, wherein the bearing has an annular recess formed substantially in the center of the circumferential surface of the bearing in the axial direction thereof, the recess engaging with the attachment means.

9. The recording medium drive according to claim 6, wherein
the pickup unit carrying mechanism includes a lead screw having a spiral groove; and
the pickup unit base further has:
an engaging member engaging elastically with the spiral groove, and
an elastic engaging member support disposed at a part of the leaf spring and supporting the engaging member.

10. The recording medium drive according to claim 3, wherein the bearing is a cylindrical oil-retaining metal bearing.

11. The recording medium drive according to claim 3, wherein
the pickup unit has a thickness of about 3 mm;
the first guide member has a diameter of about 1.5 mm; and
the bearing has an outer diameter of about 2.3 mm.

12. An electronic device comprising a recording medium drive having a drive unit including:
a drive unit base including
a motor for driving a recording medium,
a pickup unit carrying mechanism, and
first and second guide members; and
a pickup unit that is supported by the first and second guide members in an opening provided in the drive unit base movably in the radial direction of the recording medium and is carried by the pickup unit carrying mechanism in the radial direction of the recording medium, the pickup unit including
a pickup unit base having pickup means for recording and/or playing back information on the recording medium,
a bearing fitted around the circumferential surface of the first guide member, and
attachment means for detachably attaching the bearing to a side of the pickup unit base.

13. A pickup unit comprising:
a pickup unit base having a pickup for recording and/or playing back information on a recording medium;
a bearing fitted around the circumferential surface of a guide member for guiding the pickup unit base; and
an attachment member for detachably attaching the bearing to a side of the pickup unit base.

14. A drive unit comprising:
a drive unit base including
a motor for driving a recording medium,
a pickup unit carrying mechanism, and
first and second guide members; and
a pickup unit supported movably by the first and second guide members in an opening provided in the drive unit base, the pickup unit including
a pickup unit base having a pickup for recording and/or playing back information on the recording medium,
a bearing fitted around the circumferential surface of the first guide member, and
an attachment member for detachably attaching the bearing to a side of the pickup unit base.

15. A recording medium drive comprising a drive unit including:
a drive unit base including
a motor for driving a recording medium,
a pickup unit carrying mechanism, and
first and second guide members; and
a pickup unit supported movably by the first and second guide members in an opening provided in the drive unit base, the pickup unit including
a pickup unit base having a pickup for recording and/or playing back information on the recording medium,
a bearing fitted around the circumferential surface of the first guide member, and
an attachment member for detachably attaching the bearing to a side of the pickup unit base.

16. An electronic device comprising a recording medium drive having a drive unit including:
a drive unit base including
a motor for driving a recording medium,
a pickup unit carrying mechanism, and
first and second guide members; and
a pickup unit that is supported by the first and second guide members in an opening provided in the drive unit base movably in the radial direction of the recording medium and is carried by the pickup unit carrying mechanism in the radial direction of the recording medium, the pickup unit including
a pickup unit base having a pickup for recording and/or playing back information on the recording medium,
a bearing fitted around the circumferential surface of the first guide member, and
an attachment member for detachably attaching the bearing to a side of the pickup unit base.
